(19) United States
(12) Patent Application Publication
(10) Pub. No.: US 2023/0292698 A1
(43) Pub. Date: Sep. 21, 2023

(54) WALL AND WINDOW MOUNTED FELINE STRUCTURES

(71) Applicant: Marc Gregory Martino, Westlake Village, CA (US)

(72) Inventor: Marc Gregory Martino, Westlake Village, CA (US)

(21) Appl. No.: 18/185,260

(22) Filed: Mar. 16, 2023

Related U.S. Application Data
(60) Provisional application No. 63/269,635, filed on Mar. 21, 2022.

(51) Int. Cl. A01K 1/035

(52) U.S. Cl. CPC A01K 1/035

(57) ABSTRACT

A structure configured to mount to a vertical surface and support a pet includes a floor, a left wall extending upwardly from the floor at a first obtuse angle and a right wall extending upwardly from the floor at a second obtuse angle. A front wall is connected to the floor, the left wall and the right wall. The front wall extends upwardly from the floor at a third obtuse angle. A rear wall is connected to the floor, the left wall and the right wall. The rear wall extends at a perpendicular angle in relation to the floor, the left wall and the right wall. The rear wall comprises a plurality of apertures spaced apart from one another configured to receive a plurality of fasteners. The rear wall is configured to attach to the vertical surface thereby attaching the structure to the vertical surface with the plurality of fasteners.

### CROSS-REFERENCE TO RELATED APPLICATIONS

This application claims priority to provisional patent application 63/269,635 filed on Mar. 21, 2022, the entire contents of which are hereby incorporated in full by this reference.

### DESCRIPTION

### Field of the Invention

The present invention generally relates to cats. More particularly, the present invention relates to a multitude of wall and window mounted structures that are to be used for a person's pet cat to play and lounge upon.

### Background of the Invention

The pet industry is a huge business, with new products constantly being offered in the marketplace. Furthermore, cats enjoy climbing and lounging in structures that are higher than the floor level, as this creates a place of safety and comfort for them. Accordingly, there is a need for new structures that are easy to install for one's pet cat and can attach to a variety of vertical surfaces commonly found. The present invention fulfills these needs and provides other related advantages.

### SUMMARY OF THE INVENTION

Referring to FIGS. 3-26, an exemplary embodiment of the present invention includes a structure (10a, 10b) configured to mount to a vertical surface (1) and configured to support a pet of an owner, the structure comprising: a floor (11); a left wall (12) connected to the floor, the left wall extending upwardly from the floor at a first obtuse angle (13) in relation to the floor; a right wall (14) connected to the floor disposed opposite the left wall, the right wall extending upwardly from the floor at a second obtuse angle (15) in relation to the floor; a front wall (16) connected to the floor, the left wall and the right wall, the front wall extending upwardly from the floor at a third obtuse angle (17) in relation to the floor; a rear wall (18) connected to the floor, the left wall and the right wall, the rear wall extending at a perpendicular angle (19) in relation to the floor, the left wall and the right wall; wherein the rear wall comprises a plurality of apertures (20) spaced apart from one another configured to receive a plurality of fasteners (21); wherein the rear wall is configured to directly abut or be near the vertical surface for attaching the structure to the vertical surface with the plurality of fasteners utilizing the plurality of apertures.

The structure is configured to nest within a second structure (10a2) of similar shape to the structure, wherein when nested the respective floors (11a and 11a2) of the structure and the second structure are a distance (22) of or less than 1 inch apart. (Actually 0.6 inches from floor to floor) In other words, the distance (22) is not to exceed 1 inch.

The structure may include the plurality fasteners, the plurality of fasteners being both a plurality of wall screws (23) and a plurality of suction cups (24a) with a threaded stud (24t) and associated nut (24n), thereby enabling the owner to attach the structure to the vertical surface being a wall (2) utilizing the plurality of wall screws or the vertical surface being a window (3) using the plurality of suction cups.

The structure may include the plurality fasteners, the plurality of fasteners being both a plurality of wall screws (23) and a plurality of adhesive pads (24b) with the threaded stud (24t) and associated nut (24n), thereby enabling the owner to attach the structure to the vertical surface being a wall (2) utilizing the plurality of wall screws or the vertical surface being a window (3) using the plurality of adhesive pads.

The structure may include the plurality fasteners, the plurality of fasteners including a plurality of wall screws (23), a plurality of suction cups (24a) with a threaded stud (24t) and associated nut (24n) and a plurality of adhesive pads (24b) with the threaded stud (24t) and associated nut (24n), thereby enabling the owner to attach the structure to the vertical surface being a wall (2) utilizing the plurality of wall screws or the vertical surface being a window (3) using the plurality of suction cups or adhesive pads.

The floor, the left wall, the right wall, the front wall and the rear wall are formed as a single injection molded plastic structure resulting in a monolithic structure.

A thickness (35) of the floor, the left wall, the right wall, the front wall and the rear wall may be at or less than 0.150 (0.125 or 0.100) inches thick.

The rear wall may be formed in the shape of a U-shaped perimeter (36), the U-shaped perimeter extending perpendicularly from the left wall, the floor and the rear wall a distance (37) equal to or less than 2 inches. (Actually 1.25 for the lounge or 1.125 for the step)

A height (25) of a top edge (26) of the front wall measured perpendicularly from the floor may be less than a height (27) of a top edge (28) of the rear wall measured perpendicularly from the floor.

A height (25) of a top edge (26) of the front wall measured perpendicularly from the floor may be equal to or less than 25% of a height (27) of a top edge (28) of the rear wall measured perpendicularly from the floor.

A top edge (29) of the left wall and a top edge (30) of the right wall may extend from the height of the top edge of the front wall to the height of the top edge of the rear wall.

The top edge of the left wall and the top edge of the right wall may be convex in shape.

The top edge of the left wall and the top edge of the right wall may both comprise a first straight section (31) being at an obtuse angle (32) with respect to a second straight section (33). The first and second straight sections may be connected by a fillet section (34).

The height of the top edge of the rear wall measured perpendicularly from the floor may be at least 7 inches (actually 8 inches for the step or 10 inches for the lounge), and wherein the height of the top edge of the front wall measured perpendicularly from the floor may be at or less than 3 inches (actually 1 inch for the step or 2 inches for the lounge) and wherein the floor may be at least 15 inches (actually 17.5 inches) in width (47) and at least 10 inches (at least 12 inches) in length (48).

The plurality of apertures may comprise at least 6 holes or at least 6 slots. Actually 7 apertures are shown for the step or 10 aperture are shown for the lounge) The front wall may be flat or curved.

The rear wall delimits a horizontal left upper edge (37), which itself is adjacent to a vertically slanted left inner edge (38), which itself is adjacent to a horizontal lower edge (39), which itself is adjacent to a vertically slanted right inner edge (40), which itself is adjacent to a horizontal right upper edge (41). Furthermore, the vertically slanted left inner edge may be parallel to the left wall and similarly the vertically slanted right inner edge may be parallel to the right wall.

The first obtuse angle is at least 95 (actually 101.3) degrees but no greater than 135 degrees, wherein the second obtuse angle is at least 95 (actually 101.3) degrees but no greater than 135 degrees, and wherein the third obtuse angle is at least 95 (actually 110) degrees.

The left wall connects to the floor with a first fillet (42) (i.e., round), wherein the right wall connects to the floor with a second fillet (43), wherein the front wall connects to the floor with a third fillet (44), wherein the left wall connects to the front wall with a fifth fillet (45) and wherein the right wall connects to the front wall with a sixth fillet (46).

Referring to FIGS. 27-38, an exemplary embodiment of the present invention includes a structure (10c) configured to mount to a vertical surface (1) and configured to support a pet of an owner, the structure comprising: a set of stairs (49) comprising a plurality of adjacently connected flat substrates (50) wherein each flat substrate is disposed perpendicular to an adjacent flat substrate; a rear wall (51) connected to each flat substrate of the plurality of flat substrates extending perpendicularly from and away from a bottom side (52) of the set of stairs; a front wall (53) disposed opposite the rear wall about the set of stairs, wherein the front wall is connected to each flat substrate of the plurality of flat substrates extending from and away from the bottom side of the set of stairs at an acute angle (54) in relation to the rear wall; wherein the rear wall comprises a plurality of apertures (20) spaced apart from one another configured to receive a plurality of fasteners (21); and wherein the rear wall is configured to directly abut or be near the vertical surface for attaching the structure to the vertical surface with the plurality of fasteners utilizing the plurality of apertures.

An end substrate (55) may abuts each last flat substrate in the set of stairs, wherein the end substrate is at an acute angle (56) in comparison to its respective last flat substrate. The acute angle shown is actually 60 degrees.

Each end substrate is connected at one end to the rear wall and connected at an opposite end to the front wall.

The set of stairs may comprise a first set (57) of at least three flat substrates disposed parallel to another and a second set (58) of at least three flat substrates disposed parallel to another, wherein the first set is disposed perpendicular in relation to the second set, and wherein the first set is disposed interwoven between the second set.

A width (59) of each flat substrate may be at least 3 inches. As shown, it is actually 4.5 inches.

A length (60) of each flat substrate may be at least 8 inches. As shown, it is actually 9 inches.

The structure is configured to nest within a second structure (10c2) of similar shape wherein when nested the respective flat substrates of the structures are a distance (61) less than 1 inch apart. As shown, it is actually 0.6 inches from floor to floor.

The set of stairs, the front wall and the rear wall are formed as a single injection molded plastic structure resulting in a monolithic structure.

A thickness (62) of the set of stairs, the front wall and the rear wall may be at or less than 0.150, 0.125 or 0.100 inches thick.

The plurality of apertures may comprise at least 6 holes or at least 6 slots. As shown, actually 9 apertures are used for the step, 10 apertures are used for the lounge and 7 apertures are used for the step.

Other features and advantages of the present invention will become apparent from the following more detailed description, when taken in conjunction with the accompanying drawings, which illustrate, by way of example, the principles of the invention.

### BRIEF DESCRIPTION OF THE DRAWINGS

The accompanying drawings illustrate the invention. In such drawings:

FIG. 1 is an isometric view of a multitude of wall and window mounted feline structures;

FIG. 2 is a front view of the structure of FIG. 1;

FIG. 3 is an isometric view of one embodiment of a wall and window mounted feline structure (i.e., cat lounge);

FIG. 4 is another isometric view of the structure of FIG. 3;

FIG. 5 is another isometric view of the structure of FIG. 3;

FIG. 6 is another isometric view of the structure of FIG. 3;

FIG. 7 is a front view of the structure of FIG. 3;

FIG. 8 is a rear view of the structure of FIG. 3;

FIG. 9 is a top view of the structure of FIG. 3;

FIG. 10 is a bottom view of the structure of FIG. 3;

FIG. 11 is a left side view of the structure of FIG. 3;

FIG. 12 is a ride side view of the structure of FIG. 3;

FIG. 13 is an isometric view of the structure of FIG. 3 showing two structures nesting within one another;

FIG. 14 is a side view of the structure of FIG. 13;

FIG. 15 is an isometric view of one embodiment of a wall and window mounted feline structure (i.e., cat step);

FIG. 16 is another isometric view of the structure of FIG. 15;

FIG. 17 is another isometric view of the structure of FIG. 15;

FIG. 18 is another isometric view of the structure of FIG. 15;

FIG. 19 is a front view of the structure of FIG. 15;

FIG. 20 is a rear view of the structure of FIG. 15;

FIG. 21 is a top view of the structure of FIG. 15;

FIG. 22 is a bottom view of the structure of FIG. 15;

FIG. 23 is a left side view of the structure of FIG. 15;

FIG. 24 is a ride side view of the structure of FIG. 15;

FIG. 25 is an isometric view of the structure of FIG. 15 showing two structures nesting within one another;

FIG. 26 is a side view of the structure of FIG. 25;

FIG. 27 is an isometric view of one embodiment of a wall and window mounted feline structure (i.e., cat stairs);

FIG. 28 is another isometric view of the structure of FIG. 27;

FIG. 29 is another isometric view of the structure of FIG. 27;

FIG. 30 is another isometric view of the structure of FIG. 27;

FIG. 31 is a front view of the structure of FIG. 27;

FIG. 32 is a rear view of the structure of FIG. 27;

FIG. 33 is a top view of the structure of FIG. 27;

FIG. 34 is a bottom view of the structure of FIG. 27;

FIG. 35 is a left side view of the structure of FIG. 27;

FIG. 36 is a ride side view of the structure of FIG. 27;

FIG. 37 is a side view taken along lines 37-37 of FIG. 31 to best illustrate the acute angle of the front wall in relation to the rear wall;

FIG. 38 is a view similar to FIG. 37 now showing two structure nesting within one another;

FIG. 39 is an isometric view of the structure of FIG. 38 showing two structures nesting within one another;

FIG. 40 is a side sectional view showing a wall fastener for attachment to a wall, such as drywall, and a suction cup with threaded stud or adhesive-backed pad with threaded stud for mounting the structures to a vertical surface, being either a window, a mirror or any smooth surface such as a tile;

FIG. 41 is an isometric view of another embodiment of a wall and window mounted feline structure;

FIG. 42 is an exploded isometric view of the structure of FIG. 40;

FIG. 43 is an isometric view of another embodiment of a wall and window mounted feline structure;

FIG. 44 is an exploded isometric view of the structure of FIG. 42;

FIG. 45 is an isometric view of an assembly of a plurality of all three structures of the present invention shown in FIG. 1 fitting into a single box for storage and shipping;

FIG. 46 is an isometric view of a holder for a cardboard scratching pad;

FIG. 47 is another isometric view of the structure of FIG. 46; and

FIG. 48 is a front view of the cat lounge structure of FIGS. 3-14 of the present invention now showing the addition of an adhesive-backed carpet or a pet bed for increased use and comfort.

### DETAILED DESCRIPTION OF THE PREFERRED EMBODIMENTS

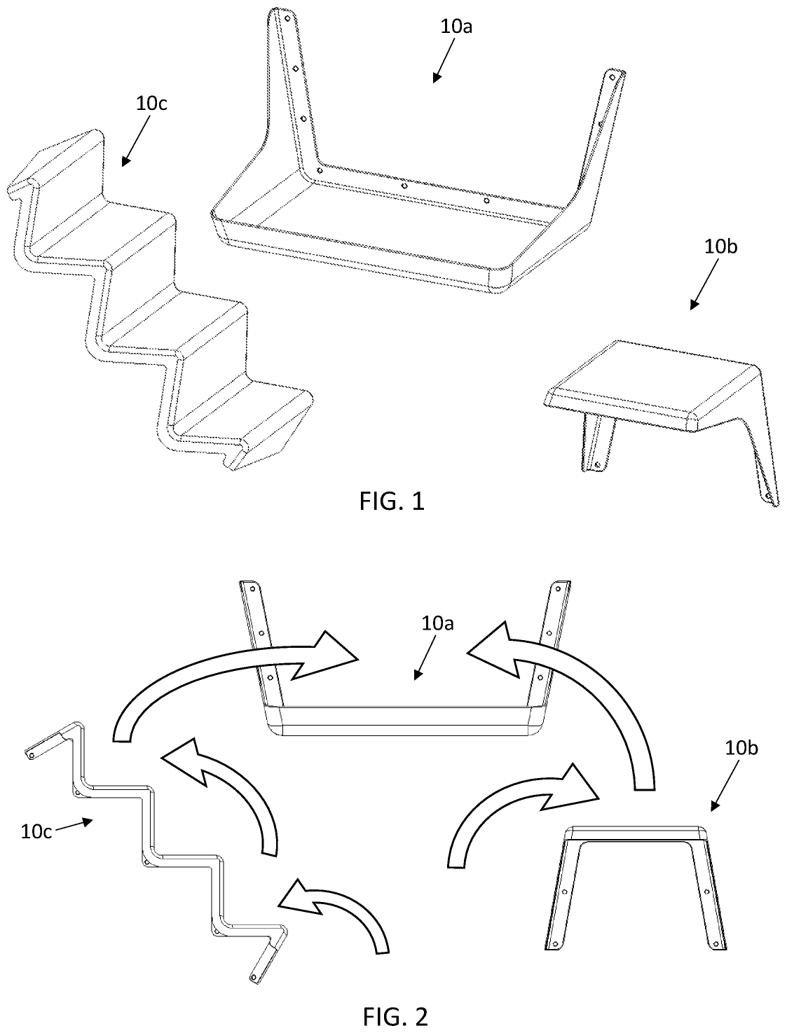

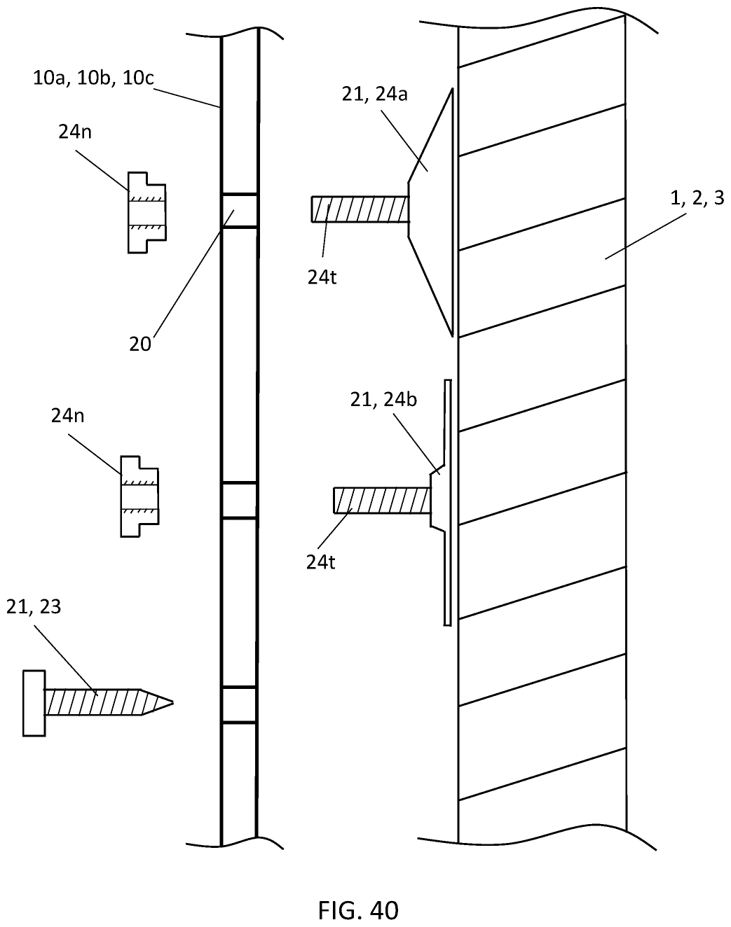

FIG. 1 is an isometric view of three different structures 10a, 10b, 10c of the present invention, where each structure is configured to mount to a vertical surface 1 (as shown in FIG. 40) and configured to support a pet of an owner. Structures 10a and 10b are very similar in overall design, where structure 10b is smaller in various dimensions in comparison to structure 10a. Structure 10a is referred to herein as a lounge. Structure 10b is referred to herein as a step. Structure 10c is referred to herein as a stair or set or set of stairs.

A plush pet pad may be placed within the lounge such that a cat may sleep and lounge within. However, it will be understood that the structure 10a may be mounted upside down thus turning the lounge into a large platform for the cat to sit and rest upon. Likewise, structure 10b may be mounted upside down. Structure 10c may be rotated 90 degrees and mounted such that the steps go up the other direction. Furthermore, an adhesive carpet may be placed upon or within the structures to aid the cat in standing or sitting upon the structures.

FIG. 2 is a front view of the structure of FIG. 1 where the arrows represent the possible paths a cat may take when traversing the various structures. It is understood that the particular layout shown herein (i.e., lounge above stairs and step) is just one of a multitude of layouts that a user can create.

As noted above, structure 10b is referred to herein as a step. It more common that the step 10b be used in the opposite orientation in comparison to the lounge 10a, however the overall shape and design is the similar that of the lounge where the steps dimensions are just smaller.

As noted above, structure 10c is referred to herein as a stair. The stair may be placed rising to the left or rising to the right when mounted upon wall, depending on how the owner wants to orientate it during installation.

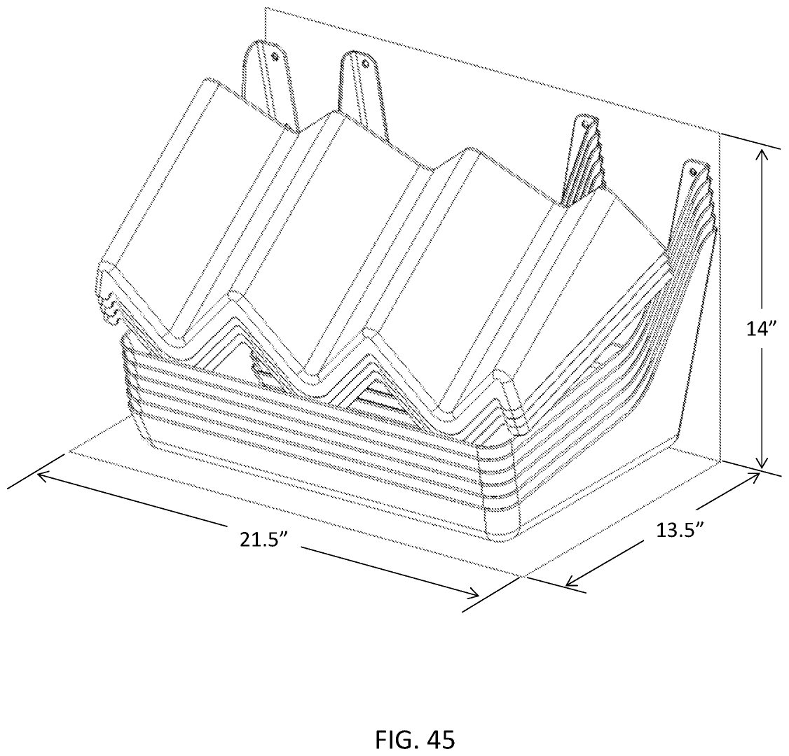

As will later be shown, the structures 10a, 10b and 10c are all designed to nest within themselves such that multiple units of each can be packaged together so that they take up little space during shipping. Furthermore, as shown in FIG. 45, a plurality of nesting structures 10b can be placed within a plurality of nesting structures 10a. Furthermore yet, a plurality of nesting structures 10c can then be placed upon the plurality of nesting structures 10a and 10b. The result is an assembly of all three structures that can be placed within a single box for shipping. This configuration maximizes the amount of units that can be packaged and shipped together thus maximizing value to the potential customer for a higher sales price for higher profitability while minimizing shipping costs and storage costs. For example, the box outline shown in FIG. 45 may be 21.5 inches by 13.5 inches by 14 inches as is currently contemplated with the production versions of the present invention.

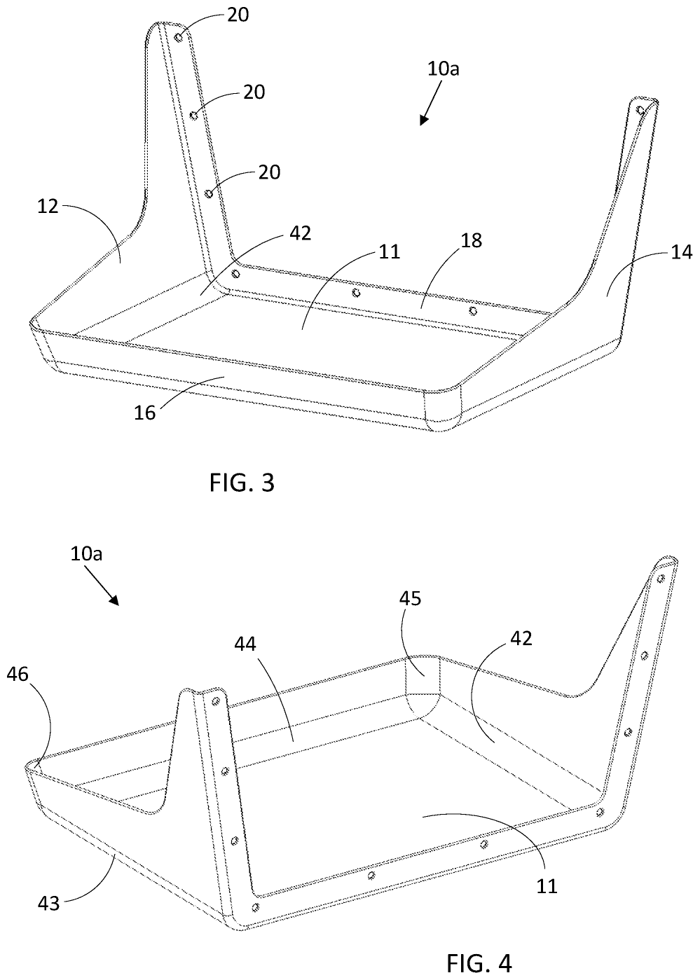

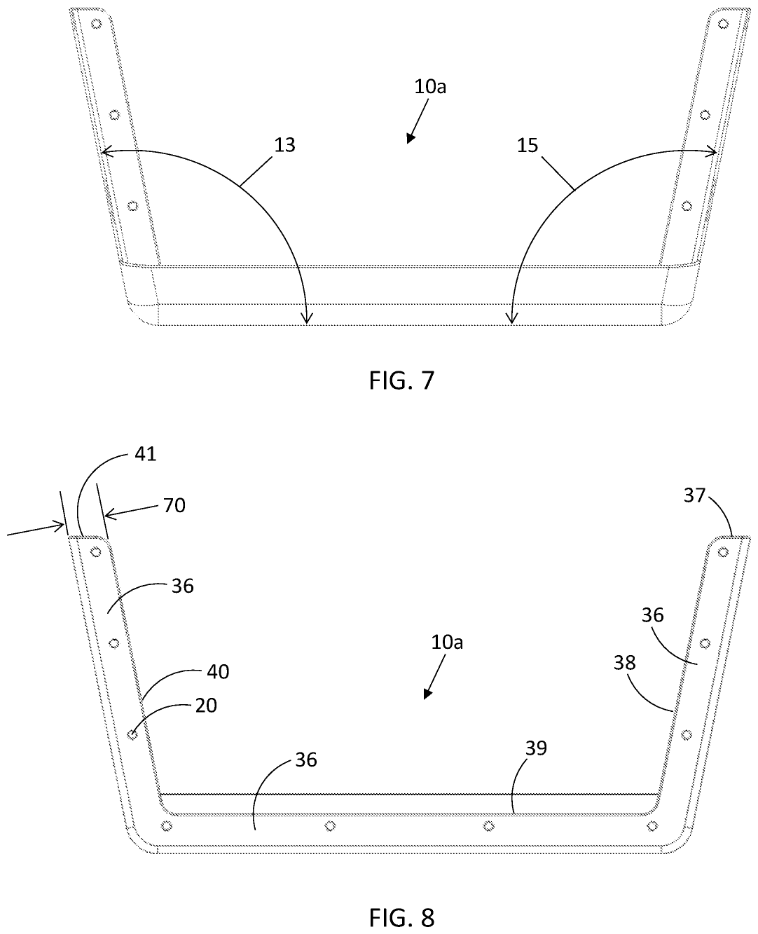

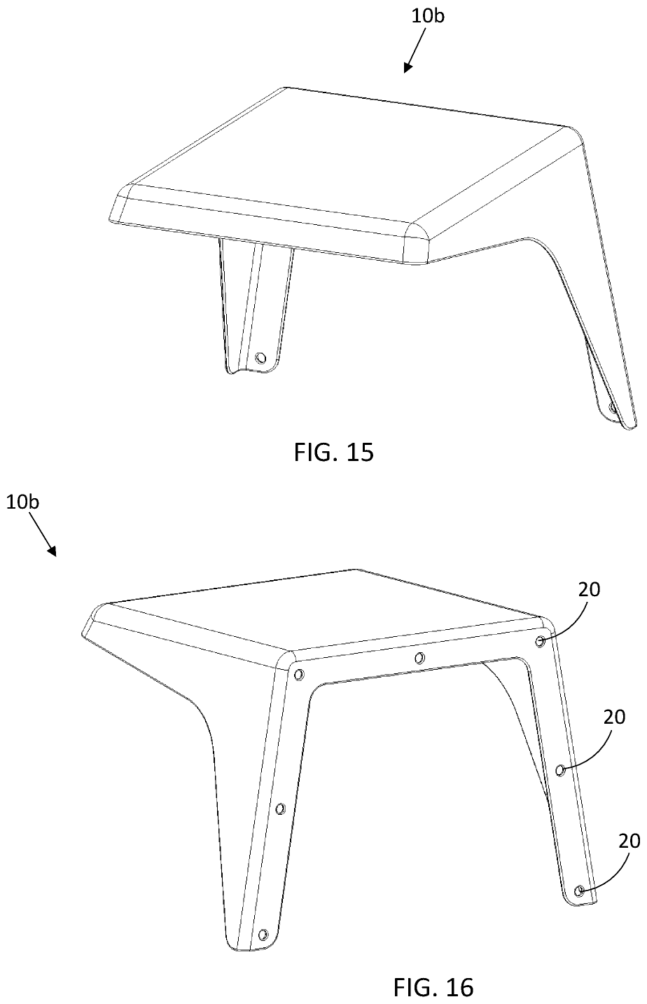

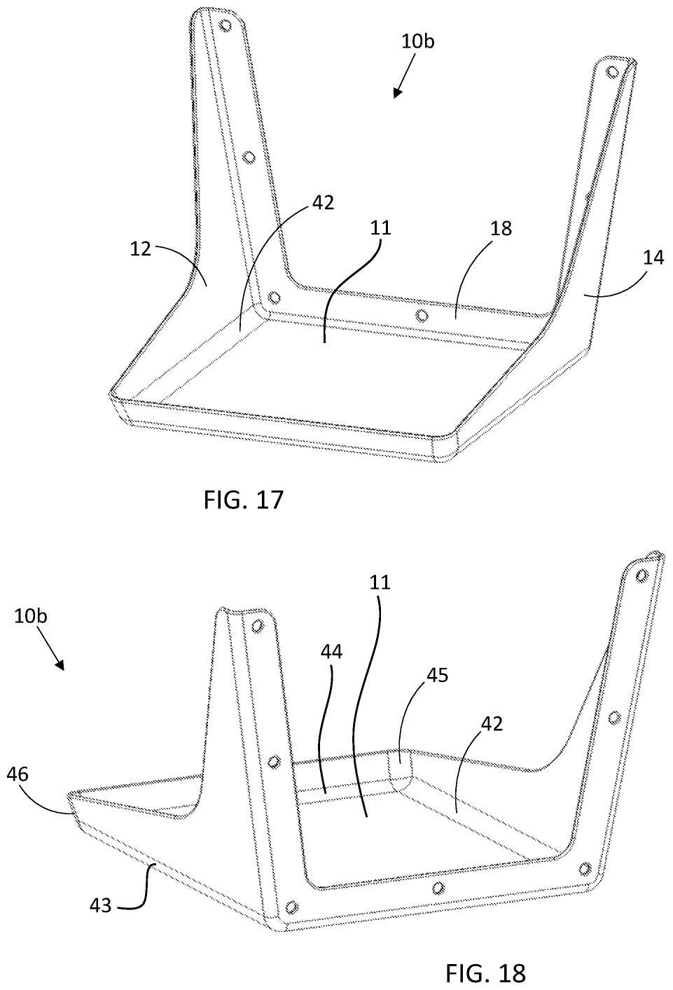

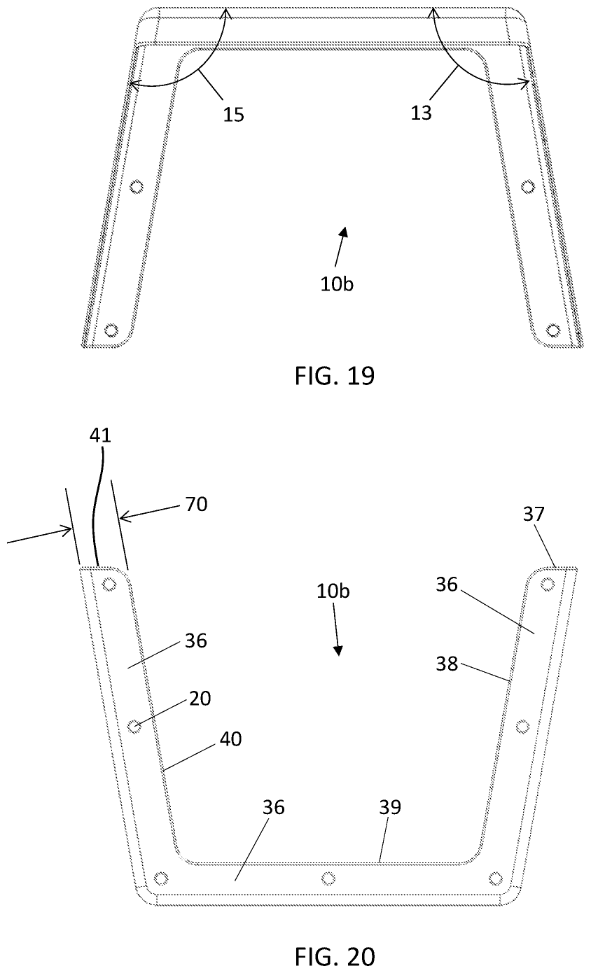

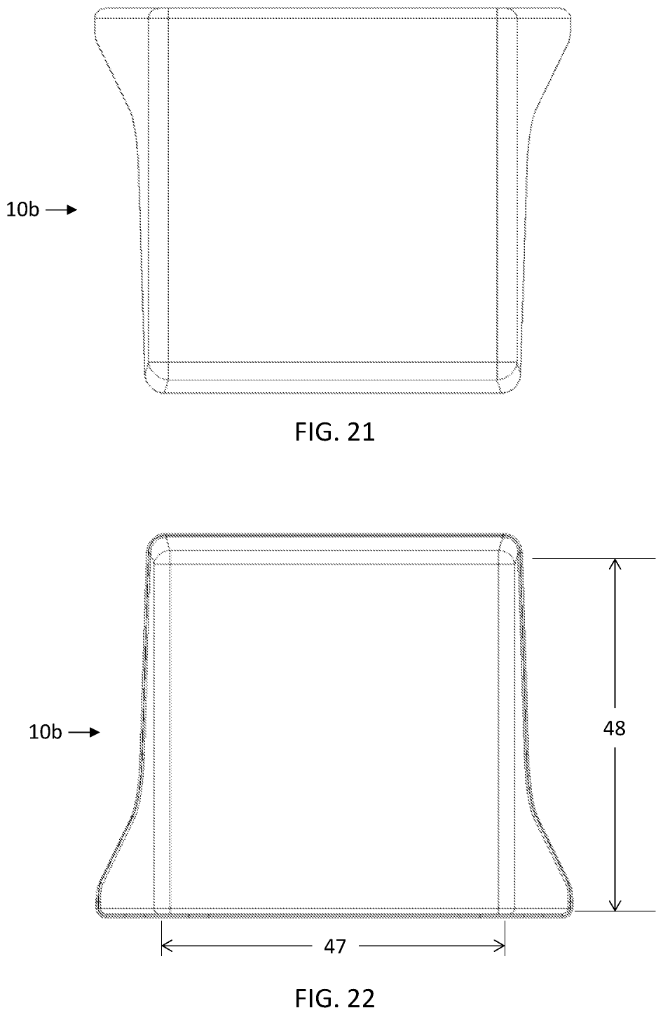

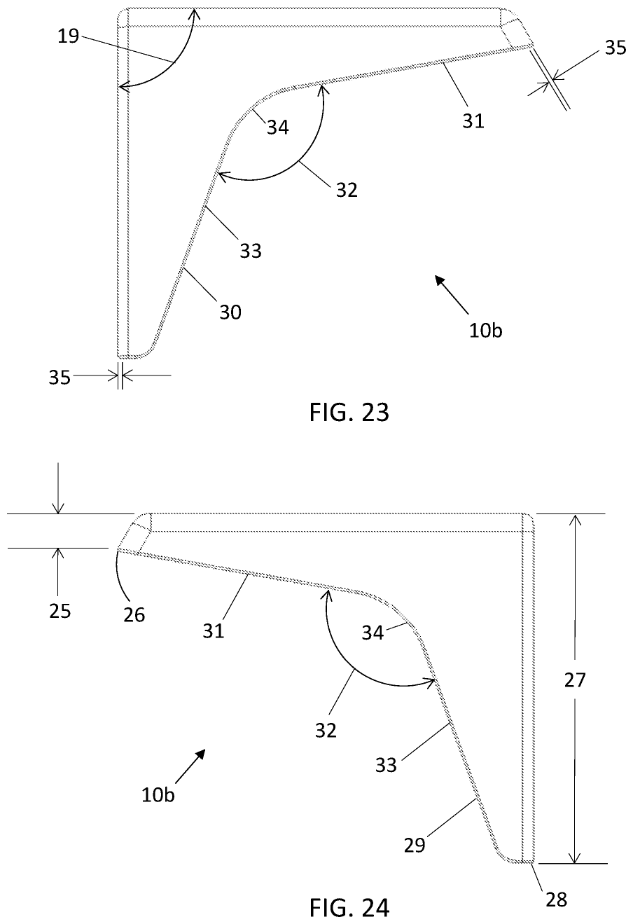

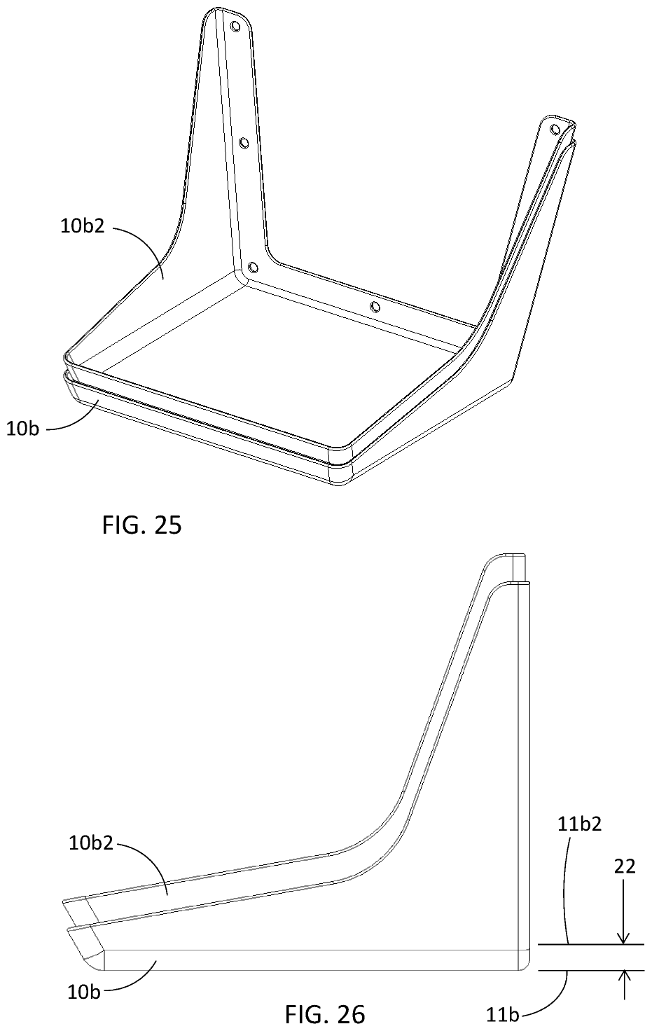

Referring to structures 10a and 10b, which are shown in FIGS. 3-26, each structure has a floor 11, a left wall 12, a right wall 14, a front wall 16 and a rear wall 18. (It is noted that the left and right wall nomenclature can be switched as references can change depending on how one views the structures and how the structures are mounted.) The left wall, right wall, rear wall and front wall are all connected to the floor. The left wall extends upwardly from the floor at a first obtuse angle 13 in relation to the floor. The first obtuse angle is at least 95 degrees, but in this embodiment is actually 101.3 degrees. The right wall is disposed opposite the left wall, as the right wall extends upwardly from the floor at a second obtuse angle 15 in relation to the floor. The second obtuse angle is at least 95 degrees, but in this embodiment is actually 101.3 degrees. The front wall extends upwardly from the floor at a third obtuse angle 17 in relation to the floor. The third obtuse angle is at least 95 degrees but in this embodiment is actually 110 degrees. These obtuse angles are necessary to allow the structures to nest within one another. The rear wall is connected to the floor, the left wall and the right wall, however the rear wall extends at a perpendicular angle 19 in relation to the floor, the left wall and the right wall.

The first obtuse angle 13 and second obtuse angle 15 should be no more than 135 degrees. Otherwise, the left and right walls become too long and/or lose their structural strength. Additionally, if the obtuse angles were too big, the structures would lose their aesthetic appeal. Preferably, the first obtuse angle 13 and second obtuse angle 15 should be no more than 112.5 degrees.

The rear wall comprises a plurality of apertures 20 spaced apart from one another configured to receive a plurality of fasteners 21 as best shown in FIG. 40. The rear wall is configured to directly abut or be near the vertical surface 1 for attaching the structure to the vertical surface with the plurality of fasteners utilizing the plurality of apertures. The plurality of fasteners can be both a plurality of wall screws 23, a plurality of suction cups 24a or a plurality of adhesive pads 24b, thereby enabling the owner to attach the structure to the vertical surface being a wall 2 (such as drywall) utilizing the plurality of wall screws or the vertical surface being a window 3 (i.e., glass or any other smooth surface) using the plurality of suction cups or adhesive pads. The plurality of apertures comprise at least 6 holes or at least 6 slots. In actuality, there are 7 apertures for the step and 10 apertures for the lounge. It is understood that the suctions cups and adhesive pads are designed to have a threaded stud 24t extending therefrom for a nut 24n to be attached on the other side. The wall screws 23 can be drywall screws, wood screws, concrete screws or any sufficient screw designed to attach to a vertical surface.

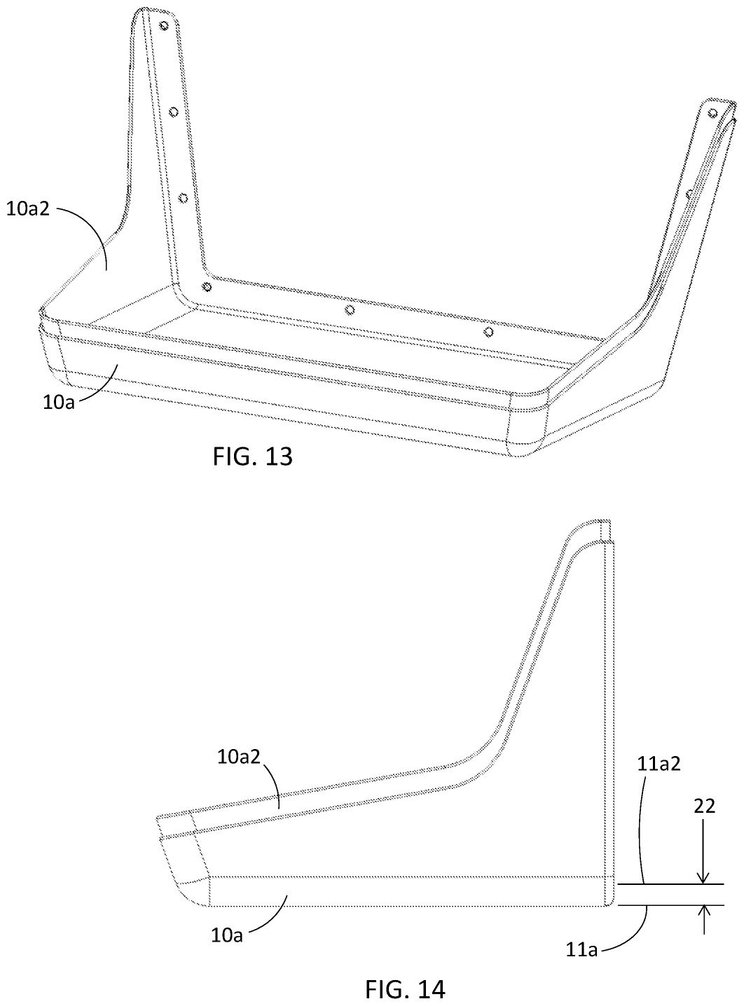

As best shown in FIGS. 13-14 and 25-26, the structures 10a or 10b are configured to nest within a second structure 10a2 or 10b2 of similar shape wherein when nested the respective floors 11a/11b and 11a2/11b2 of the structures are a distance 22 less than 1 inch apart. In this embodiment, the distance 22 is actually 0.6 inches from floor to floor, that being the same respective side of each floor to floor whether that is the top-side of the floors to one another or the bottom-side of the floors to one another.

Referring back to FIGS. 3-26, the floor, the left wall, the right wall, the front wall and the rear wall are formed as a single injection molded plastic structure resulting in a monolithic structure. Accordingly, a thickness 35 of the floor, the left wall, the right wall, the front wall and the rear wall are at or less than 0.150, 0.125 or 0.100 inches thick. In these embodiments the thickness is actually 0.10 inches thick.

Referring to FIGS. 8 and 20, the rear wall is formed in the shape of a U-shaped perimeter 36. The U-shaped perimeter extending perpendicularly from the left wall, the floor and the rear wall a distance 70 less than 2 inches. In these embodiments, the distance 70 is actually 1.25 inches for the lounge or 1.125 inches for the step.

The U-shaped perimeter of the lounge and step is actually a very important aspect of the present invention. When the lounge and step are mounted upon a window and directly viewed from the front, the visual impact of the structures are minimized. This allows the user to still see through the structures such that its visual impact is minimized. Furthermore, this also enables the cat to view directly out the window as well, thus enhancing the experience of the owner's pet (i.e., cat).

Referring to FIGS. 12 and 24, a height 25 of a top edge 26 of the front wall measured perpendicularly from the floor is less than a height 27 of a top edge 28 of the rear wall measured perpendicularly from the floor. The height 25 of the top edge of the front wall measured perpendicularly from the floor is at or less than 3 inches. In FIG. 12 the height 25 is actually 2 inches for the lounge and in FIG. 24 the height 25 is actually 1 inch for the step. The height 27 of the top edge of the rear wall measured perpendicularly from the floor is at least 7 inches. In FIG. 12 the height 27 is actually 10 inches for the lounge and in FIG. 24 the height 27 is actually 8 inches for the step. This means that for the lounge the ratio of heights of front wall to rear wall is 2/10=20%. Thus, it is less than 25%. Similarly, this means for the step the ratio of the heights of the front wall to rear wall is ⅛=12.5%, thus it is less than 15%.

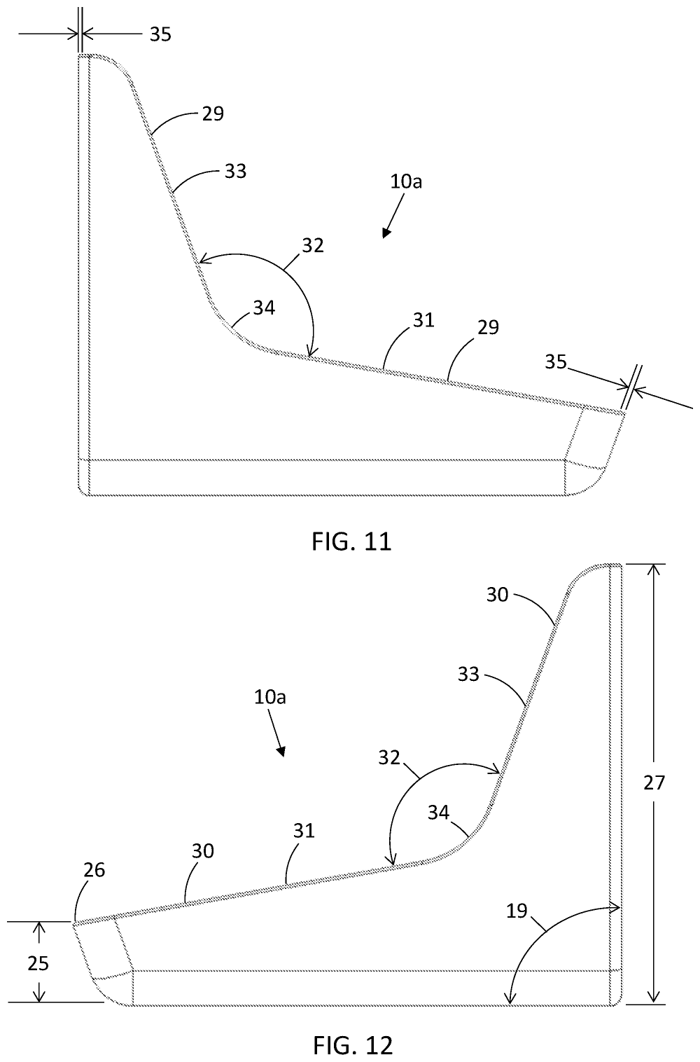

As best shown in FIGS. 11, 12 and 23, 24, a top edge 29 of the left wall and a top edge 30 of the right wall extend from the height of the top edge of the front wall to the height of the top edge of the rear wall. As can be seen, the top edge of the left wall and the top edge of the right wall are convex in shape. In other words, the top edge of the left wall and the top edge of the right wall both comprise a first straight section 31 being at an obtuse angle 32 with respect to a second straight section 33. The first and second straight sections are connected by a fillet section 34. The obtuse angle is important because it allows and/or eases the cat's access to enter the lounge or the step from the side without having to navigate past the side walls if they were made from a straight section. In other words, the obtuse angles make it easy for the cats to get in and out of the structures 10a and 10b.

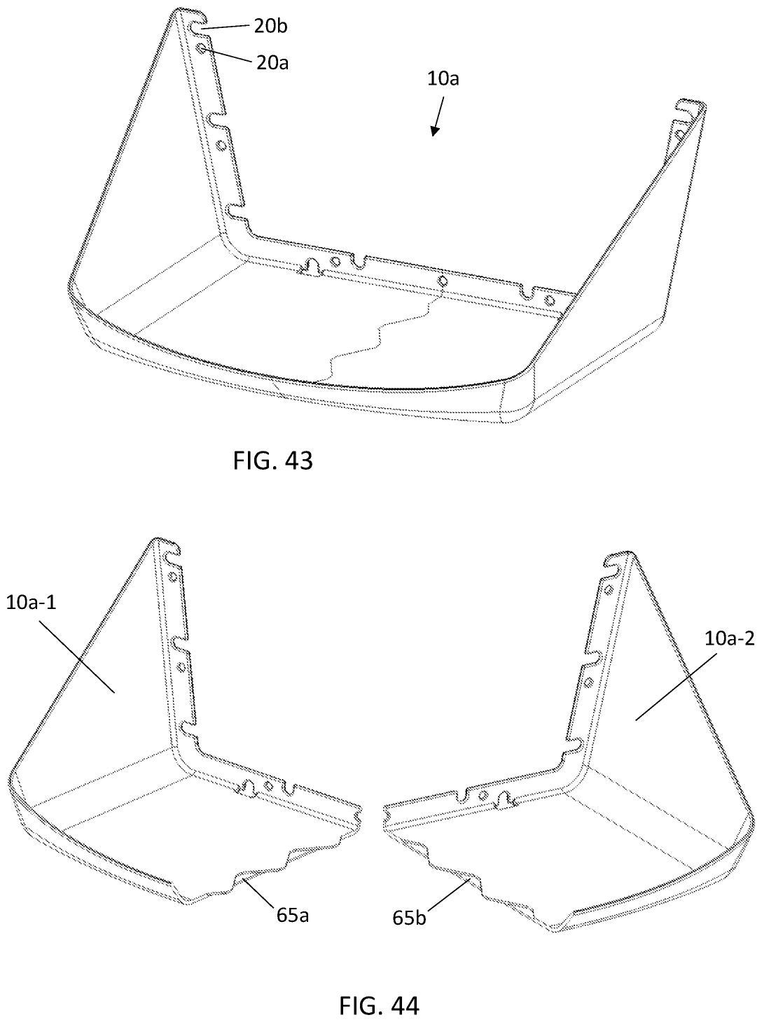

As shown herein, the front wall is usually flat. However, as shown in FIG. 43 the front wall may be curved.

Referring to FIGS. 8 and 20, the rear wall delimits a horizontal left upper edge 37, which itself is adjacent to a generally vertical (slanted) left inner edge 38, which itself is adjacent to a horizontal lower edge 39, which itself is adjacent to a generally vertical slanted right inner edge 40, which itself is adjacent to a horizontal right upper edge 41.

Referring to FIGS. 3, 4, 17 and 18 the left wall connects to the floor with a first fillet 42 (i.e., round). The right wall connects to the floor with a second fillet 43. The front wall connects to the floor with a third fillet 44. The left wall connects to the front wall with a fifth fillet 45 and the right wall connects to the front wall with a sixth fillet 46.

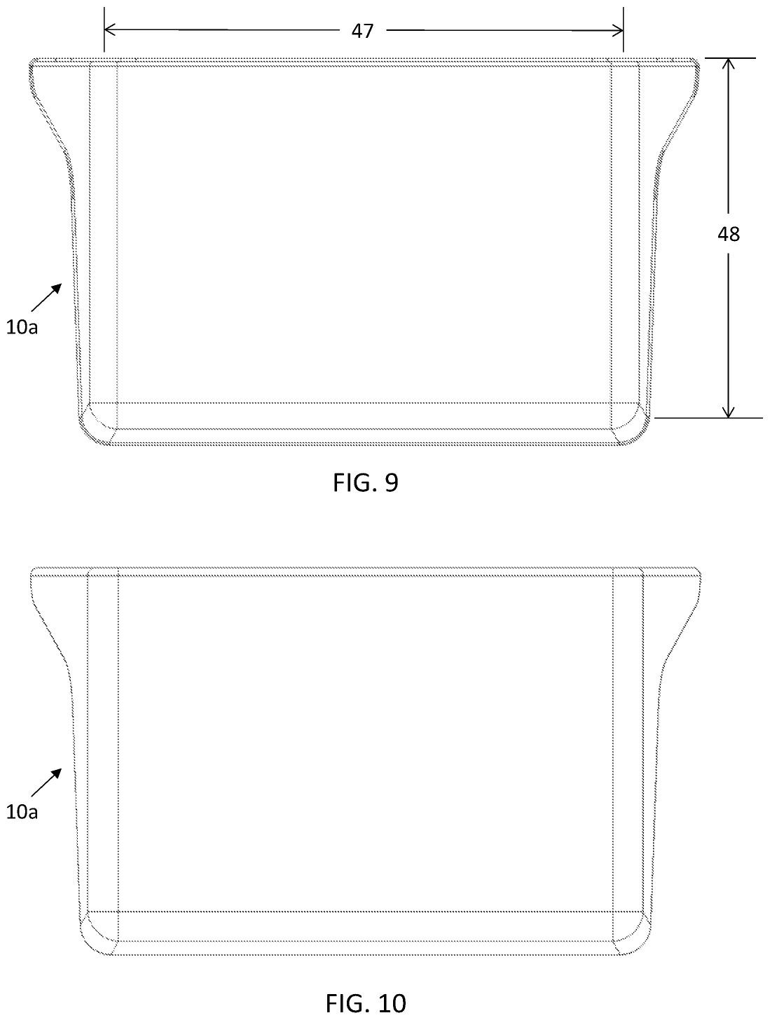

Referring to FIG. 9 the floor is at least 15 inches (actually 17.5 inches) in width 47 and at least 10 inches (actually 12 inches) in length 48. Referring to FIG. 22 the floor is at least 6 inches (actually 9 inches) in width 47 and at least 6 inches (actually 9 inches) in length 48.

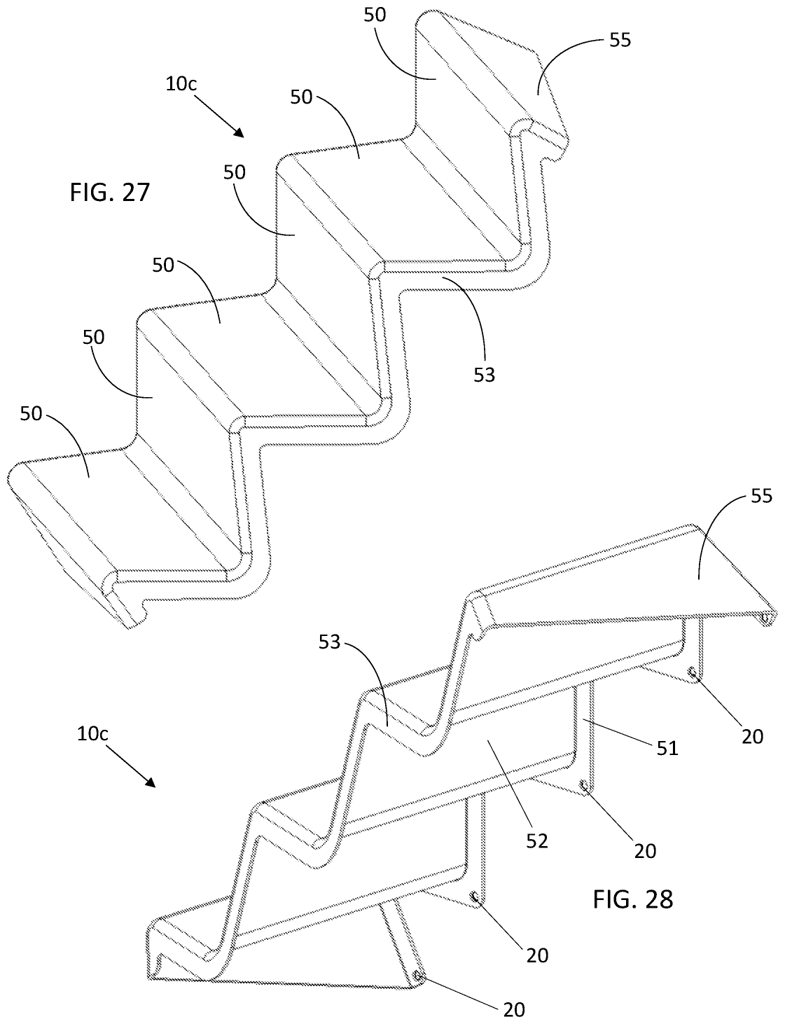

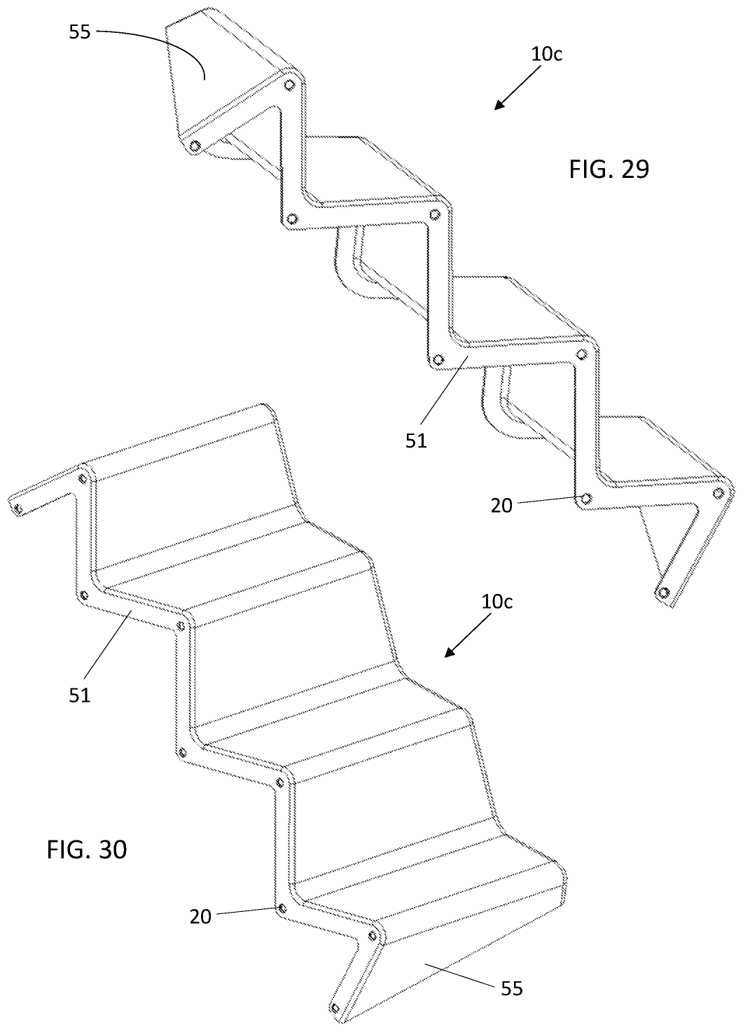

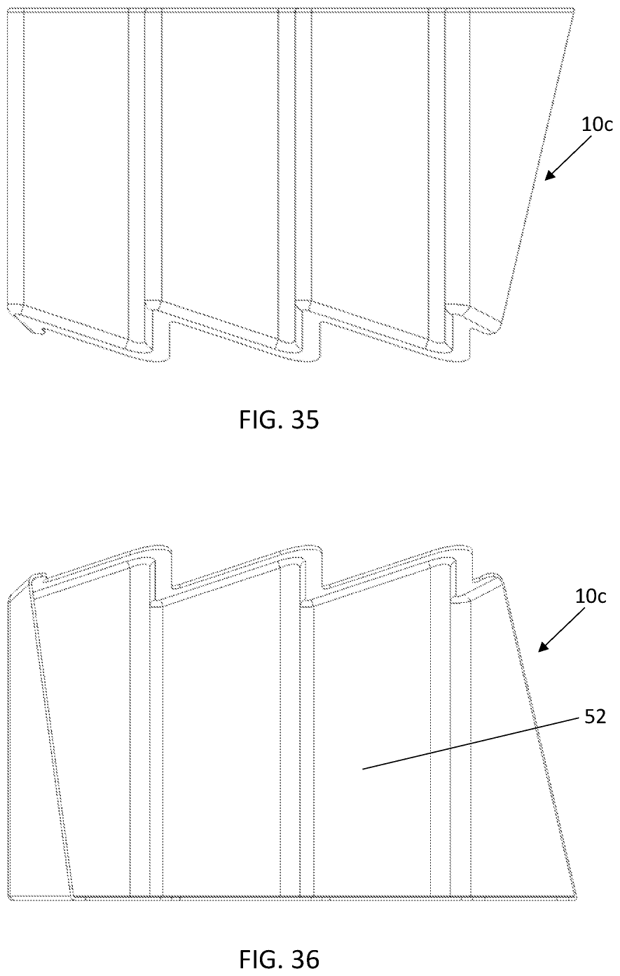

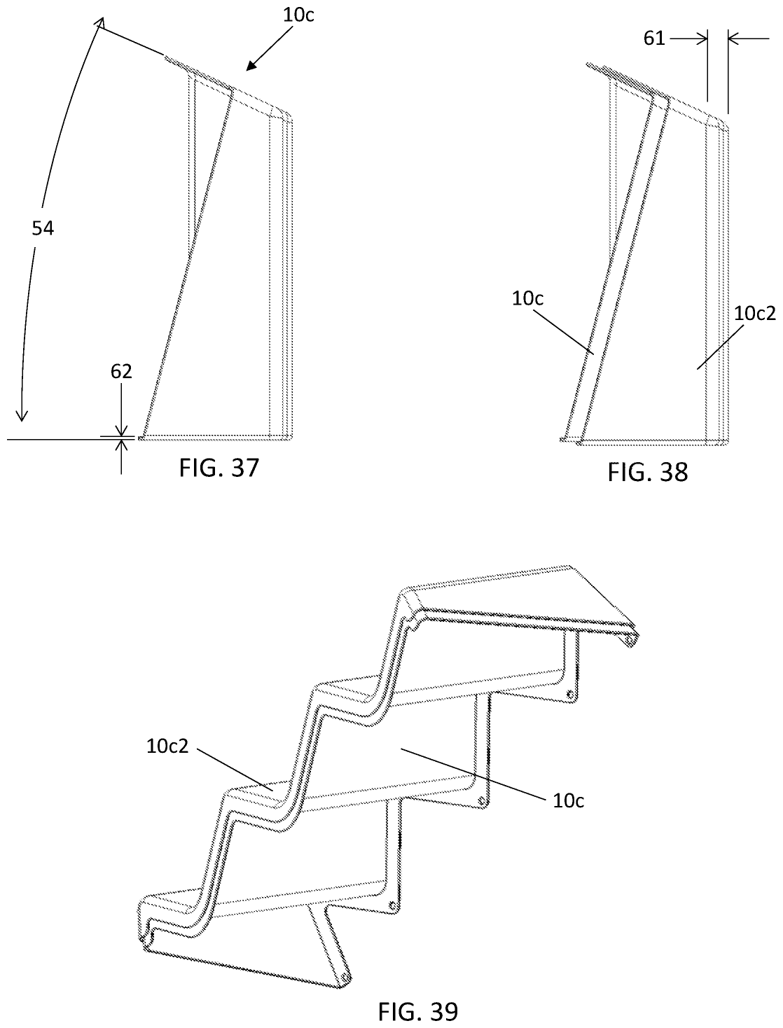

Referring now to FIGS. 27-38, a structure 10c is a set of stairs 49 that are also configured to mount to the vertical surface 1 and configured to support the pet of the owner. The set of stairs comprise a plurality of adjacently connected flat substrates 50 wherein each flat substrate is disposed perpendicular to an adjacent flat substrate. A rear wall 51 is connected to each flat substrate of the plurality of flat substrates extending perpendicularly from and away from a bottom side 52 of the set of stairs. A front wall 53 is disposed opposite the rear wall about the set of stairs, wherein the front wall is connected to each flat substrate of the plurality of flat substrates extending from and away from the bottom side of the set of stairs at an acute angle 54 in relation to the rear wall.

Similar to the other structures, the rear wall of the structure of 10c comprises the plurality of apertures 20 spaced apart from one another configured to receive a plurality of fasteners 21. As previously taught, the rear wall is configured to directly abut or be near the vertical surface for attaching the structure to the vertical surface with the plurality of fasteners 24 utilizing the plurality of apertures. The plurality of apertures comprise at least 6 holes or at least 6 slots. Actually 9 apertures are used and shown herein for the structure 10c.

An end substrate 55 abuts each last flat substrate in the set of stairs, wherein the end substrate is at an acute angle 56 in comparison to its respective last flat substrate. As shown herein, the acute angle is actually 60 degrees. As can be seen from the figures, each end substrate is connected at one end to the rear wall and connected at an opposite end to the front wall.

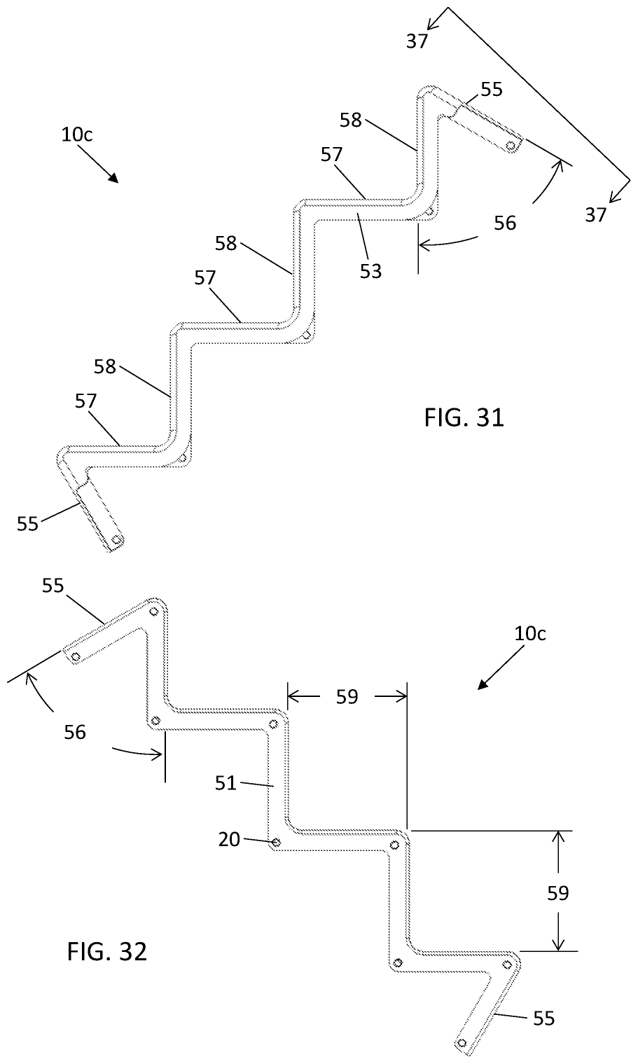

Referring now to FIG. 31, the set of stairs comprise a first set 57 of at least three flat substrates disposed parallel to another and a second set 58 of at least three flat substrates disposed parallel to another. As shown, the first set is disposed perpendicular in relation to the second set, wherein the first set is disposed interwoven between the second set. This means that a substrate 57 is perpendicular to a substrate 58, which itself is perpendicular to another substrate 57 in a repeating manner thus creating the set of stairs.

Referring to FIG. 32, a width 59 of each flat substrate is at least 3 inches. As shown herein, the width is actually 4.5 inches.

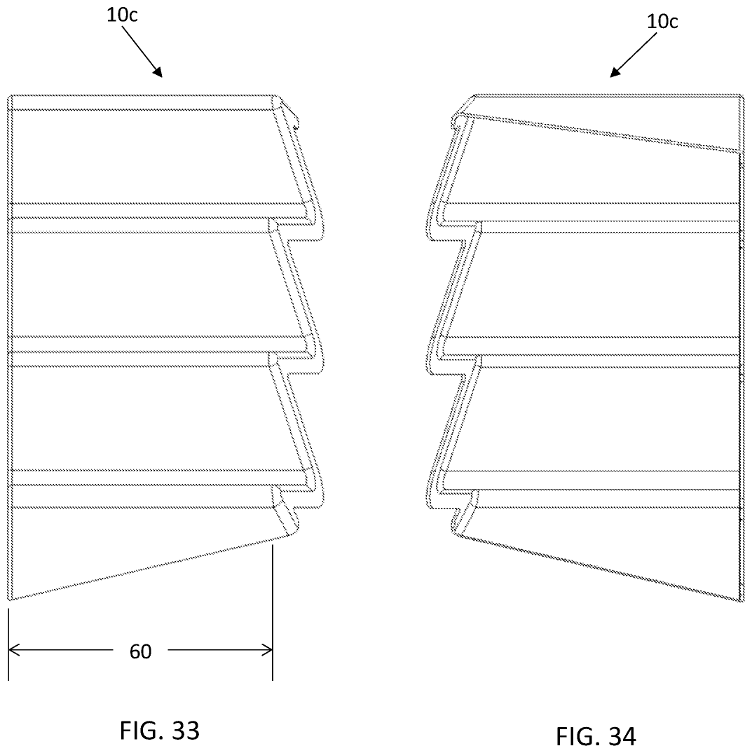

Referring to FIG. 33, a length 60 of each flat substrate is at least 8 inches. As shown herein, the length is actually 9 inches and extends furthermore at the corner ends.

As shown in FIGS. 38 and 39, the structure 10c is configured to nest within a second structure 10c2 of similar shape wherein when nested the respective flat substrates of the structures are a distance 61 less than 1 inch apart. As shown here, the distance 61 is actually 0.6 inches from respective structure to structure.

As shown herein, the structure 10c including the set of stairs, the front wall and the rear wall are formed as a single injection molded plastic structure resulting in a monolithic structure. A thickness 62 of the set of stairs, the front wall and the rear wall are at or less than 0.150, 0.125 or 0.100 inches thick. As shown herein, the thickness 62 is actually 0.10 inches thick.

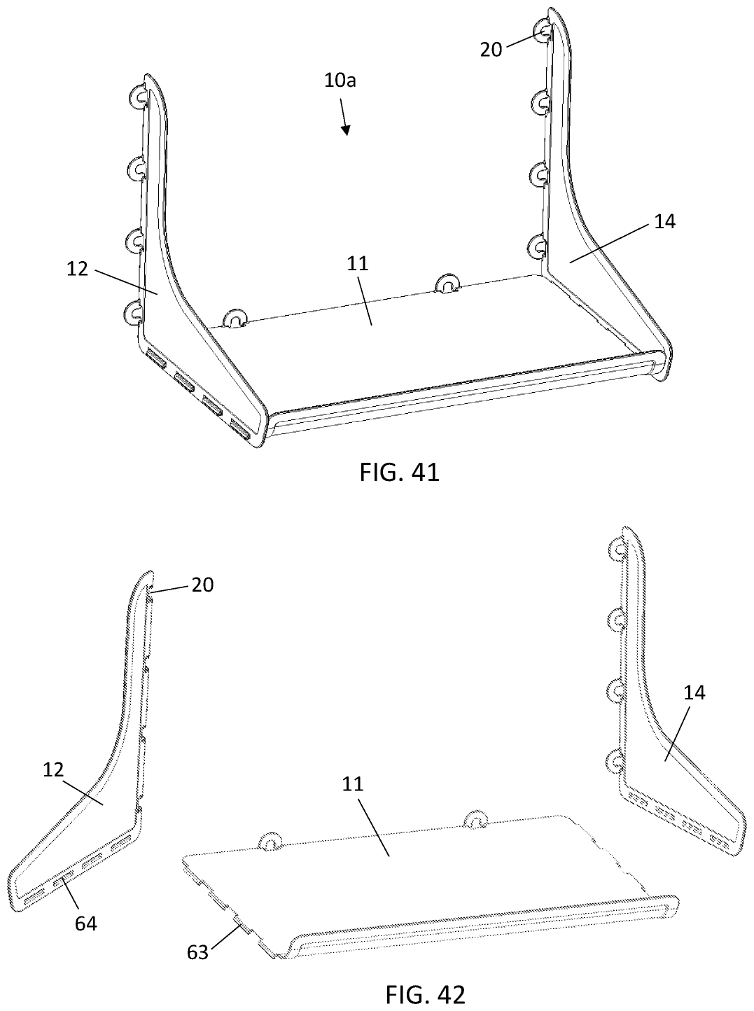

FIGS. 41 and 42 illustrate another embodiment of the lounge 10a (or step 10b) of the present invention. Here, the floor 11 is a separately manufactured part that connects to the left wall 12 and the right wall 14. The floor has hooks 63 that are configured to capture within apertures 64 formed in the left and right walls. Also, the apertures 20 are formed as slots.

FIGS. 43 and 44 illustrate yet another embodiment of the lounge 10a of the present invention. Here, the structure has been divided into two halves 10a-1 and 10a-2. The two halves can be fastened together or joined through a bond or adhesive. This embodiment was realized during development of the invention as the inventor's 3D printer could not handle large prints. Thus, the 3D model was designed in halves which could later be joined for testing. To facilitate a strong adhesive bond each half had an oppositely shaped bond feature 65a and 65b that perfectly fit within the opposing part such that a bond could be achieved over a sufficient surface area.

FIG. 45 is an isometric view of an assembly of a plurality of all three structures of FIGS. 1-40 of the present invention fitting into a single box for storage and shipping. Here, the box is 21.5 inches by 13.5 inches by 14 inches. By creating three different structures that nest within each other, a lot of value can be packaged into a single box. The box still has room for fasteners, pet pads and other items. Furthermore, a higher price can be charged to each box as a single box contains a lot of value.

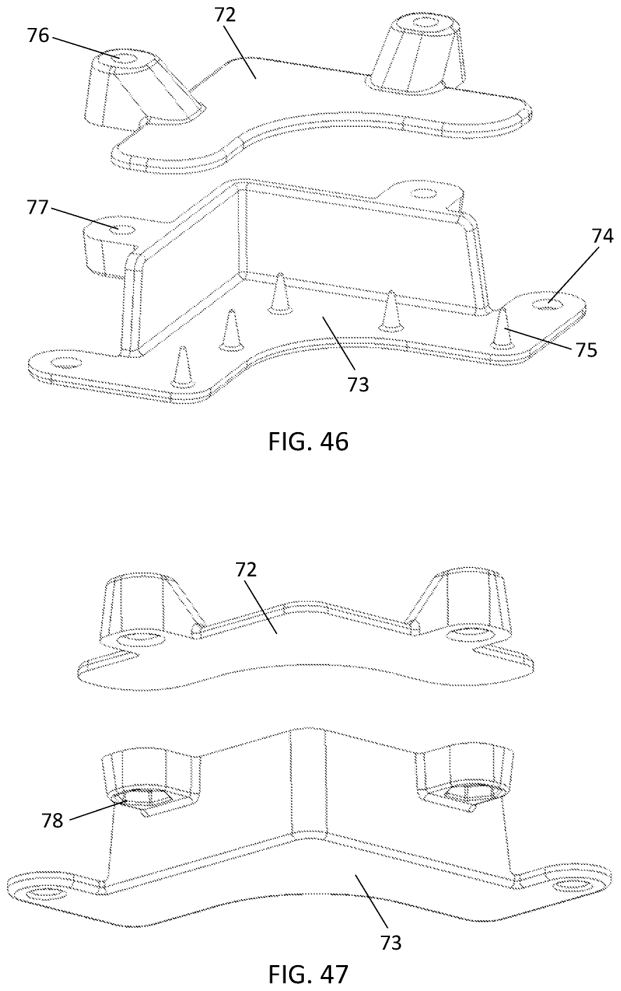

FIG. 46 is an isometric view of a holder for a cardboard scratching pad and FIG. 47 is another isometric view of the structure of FIG. 46. Typically, the cat scratching pad is rectangular in shape, such that four of the present inventions would be utilized at each corner. The holder has a top part 72 and a bottom part 73. The bottom part is placed against the wall or glass and the fastener hole 74 can be used with the suction cups or screws of the present invention. The cardboard is held in place by the spikes 75 and by the top 72 that is then fastened to the bottom part 73. Here, a fastener (not shown) can be placed through the features 76 and 77 to bring the two parts together thereby sandwiching the cardboard scratching pad. The hole 78 may be hex-shaped to fit a nut such that it captures the nut from rotating for ease of use.

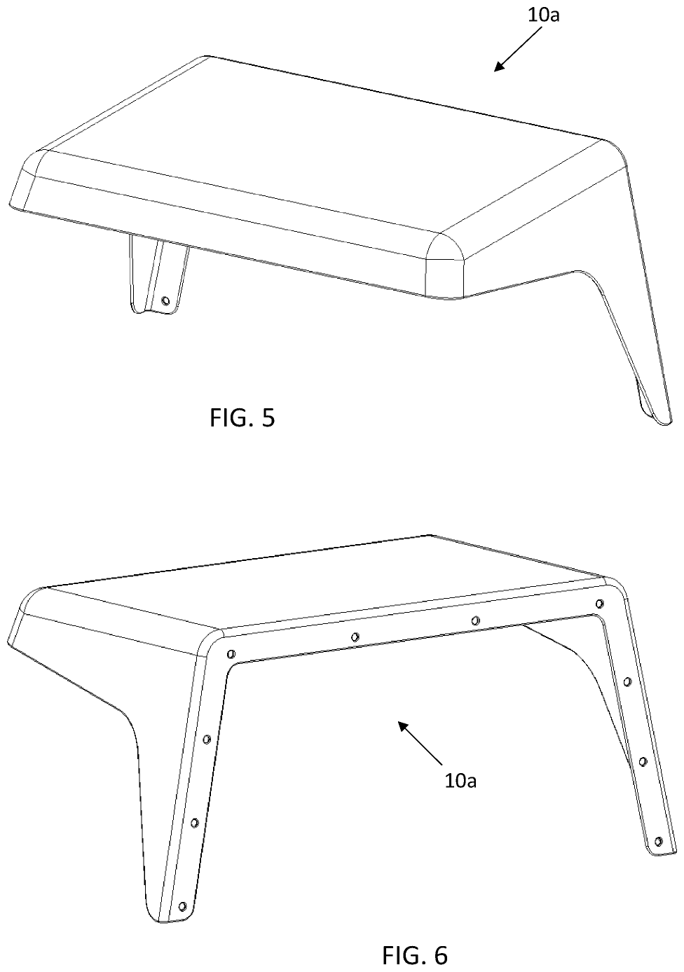

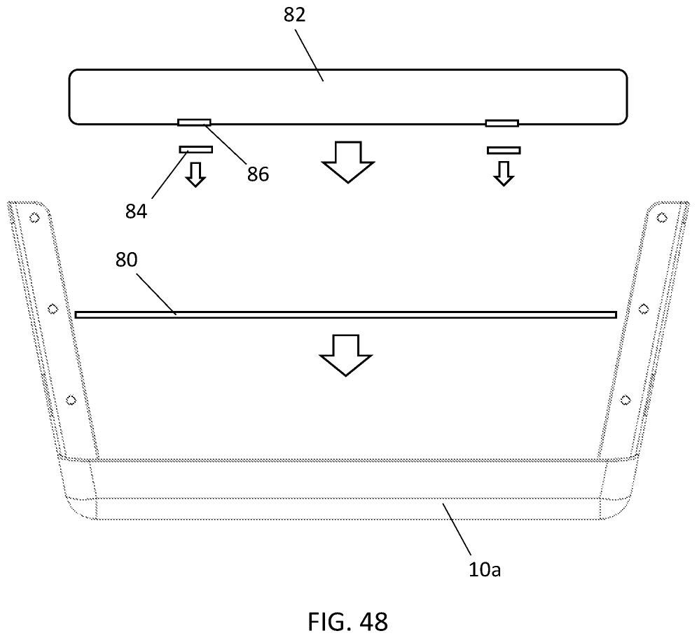

FIG. 48 illustrates that the lounge 10a shown best in FIGS. 3-14 can include an adhesive-backed carpet floor 80 that is attached to the upper surface, whether the lounge is oriented as shown in FIG. 3 or FIG. 5. The carpet pad 80 helps to give the cat something to grip onto. Likewise, a carpet pad 80 can be configured to fit and attach to the step structure 10b and stair structure 10c as taught herein.

Additionally, the lounge (or step) can include a pet bed 82 that is match fitted to fit perfectly inside the basin formed by the lounge structure. The pet bed 82 could be a foam structure and/or a fabric structure stuffed with cushioning. A plush outside covering that is soft to the touch would entice the cat to come and sit in the structures. The outside covering could include a zipper to remove the inner stuffing prior to laundering.

To prevent movement of the pet bed, a hook-and-loop fastener 84, 86 could be utilized where one portion 84 is adhered to the surface of the structure and another portion 86 is sewn or attached to the pet bed. Ideally, the portion 84 would be an adhesive-backed hook portion and the portion 86 would be the fabric based loop portion. In this manner, the pet bed could be easily removed for cleaning/laundering while still securing the pet bed to the structures for pet use. Securing the pet bed to the lounge helps keep the pet bed in place when a cat enters or leaves the lounge, as they have a tendency to jump and overtime the lounge can shift undesirably within the lounge.

The structures 10a, 10b, 10c could be made from polymers (i.e., plastic), fiber glass, composites, carbon fiber and the like or any combination thereof. Practically, the structures would be made from plastic by injection molded such that they result in a single monolithic structure. The plastics used could be ABS, polycarbonate or any suitable plastic that will retain it structural strength when exposed to sunlight and continued use. It is expected that the structures will remain functional for many years, if not decades of use.

Although several embodiments have been described in detail for purposes of illustration, various modifications may be made to each without departing from the scope and spirit of the invention. Accordingly, the invention is not to be limited, except as by the appended claims.

What is claimed is:

1. A structure configured to mount to a vertical surface and configured to support a pet of an owner, the structure comprising:
a floor;
a left wall connected to the floor, the left wall extending upwardly from the floor at a first obtuse angle in relation to the floor;
a right wall connected to the floor disposed opposite the left wall, the right wall extending upwardly from the floor at a second obtuse angle in relation to the floor;
a front wall connected to the floor, the left wall and the right wall, the front wall extending upwardly from the floor at a third obtuse angle in relation to the floor;
a rear wall connected to the floor, the left wall and the right wall, the rear wall extending at a perpendicular angle in relation to the floor, the left wall and the right wall;
wherein the rear wall comprises a plurality of apertures spaced apart from one another configured to receive a plurality of fasteners;
wherein the rear wall is configured to directly abut or be near the vertical surface for attaching the structure to the vertical surface with the plurality of fasteners utilizing the plurality of apertures.

2. The structure of claim 1, wherein the structure is configured to nest within a second structure of similar shape to the structure, wherein when nested the respective floors of the structure and the second structure are a distance of or less than 1 inch apart.

3. The structure of claim 1, including the plurality fasteners, the plurality of fasteners being both a plurality of wall screws and a plurality of suction cups with a threaded stud and an associated nut, thereby enabling the owner to attach the structure to the vertical surface being a wall utilizing the plurality of wall screws or the vertical surface being a window using the plurality of suction cups with the threaded stud and the associated nut.

4. The structure of claim 1, including the plurality fasteners, the plurality of fasteners being both a plurality of wall screws and a plurality of adhesive pads with a threaded stud and an associated nut, thereby enabling the owner to attach the structure to the vertical surface being a wall utilizing the plurality of wall screws or the vertical surface being a window using the plurality of adhesive pads with the threaded stud and the associated nut.

5. The structure of claim 1, including the plurality fasteners, the plurality of fasteners including a plurality of wall screws, a plurality of suction cups with a threaded stud and an associated nut and a plurality of adhesive pads with a threaded stud and an associated nut, thereby enabling the owner to attach the structure to the vertical surface being a wall utilizing the plurality of wall screws or the vertical surface being a window using either the plurality of suction cups with the threaded stud and the associated nut or the plurality of adhesive pads with the threaded stud and associated nut.

6. The structure of claim 1, wherein the floor, the left wall, the right wall, the front wall and the rear wall are formed as a single injection molded plastic structure resulting in a monolithic structure.

7. The structure of claim 6, wherein a thickness of the floor, the left wall, the right wall, the front wall and the rear wall are at or less than 0.150 inches thick.

8. The structure of claim 1, wherein the rear wall is formed in the shape of a U-shaped perimeter, the U-shaped perimeter extending perpendicularly from the left wall, the floor and the rear wall a distance equal to or less than 2 inches.

9. The structure of claim 1, wherein a height of a top edge of the front wall measured perpendicularly from the floor is less than a height of a top edge of the rear wall measured perpendicularly from the floor.

10. The structure of claim 1, wherein a height of a top edge of the front wall measured perpendicularly from the floor is equal to or less than 25% of a height of a top edge of the rear wall measured perpendicularly from the floor.

11. The structure of claim 9, wherein a top edge of the left wall and a top edge of the right wall respectively extend from the height of the top edge of the front wall to the height of the top edge of the rear wall.

12. The structure of claim 11, wherein the top edge of the left wall and the top edge of the right wall are convex in shape.

13. The structure of claim 11, wherein the top edge of the left wall and the top edge of the right wall both comprise a first straight section being at an obtuse angle with respect to a second straight section.

14. The structure of claim 13, wherein the first and second straight sections are connected by a fillet section.

15. The structure of claim 14, wherein the height of the top edge of the rear wall measured perpendicularly from the floor is at least 7 inches, and wherein the height of the top edge of the front wall measured perpendicularly from the floor is at or less than 3 inches, and wherein the floor is at least 15 inches in width and at least 10 inches in length.

16. The structure of claim 1, wherein the plurality of apertures comprise at least 6 holes or at least 6 slots and wherein the front wall is flat or curved.

17. The structure of claim 1, wherein the rear wall delimits a horizontal left upper edge, which itself is adjacent to a vertically slanted left inner edge, which itself is adjacent to a horizontal lower edge, which itself is adjacent to a vertically slanted right inner edge, which itself is adjacent to a horizontal right upper edge, wherein the vertically slanted left inner edge is parallel to the left wall and similarly the vertically slanted right inner edge is parallel to the right wall.

18. The structure of claim 1, wherein the first obtuse angle is at least 95 degrees but no greater than 135 degrees, wherein the second obtuse angle is at least 95 degrees but no greater than 135 degrees, and wherein the third obtuse angle is at least 95 degrees.

19. The structure of claim 1, wherein the left wall connects to the floor with a first fillet, wherein the right wall connects to the floor with a second fillet, wherein the front wall connects to the floor with a third fillet, wherein the left wall connects to the front wall with a fifth fillet and wherein the right wall connects to the front wall with a sixth fillet.

20. A structure configured to mount to a vertical surface and configured to support a pet of an owner, the structure comprising:
a floor;
a left wall connected to the floor, the left wall extending upwardly from the floor at a first obtuse angle in relation to the floor;
a right wall connected to the floor disposed opposite the left wall, the right wall extending upwardly from the floor at a second obtuse angle in relation to the floor;
a front wall connected to the floor, the left wall and the right wall, the front wall extending upwardly from the floor at a third obtuse angle in relation to the floor;
a rear wall connected to the floor, the left wall and the right wall, the rear wall extending at a perpendicular angle in relation to the floor, the left wall and the right wall;
wherein the rear wall comprises a plurality of apertures spaced apart from one another configured to receive a plurality of fasteners;
wherein the rear wall is configured to directly abut or be near the vertical surface for attaching the structure to the vertical surface with the plurality of fasteners utilizing the plurality of apertures;
wherein the structure is configured to nest within a second structure of similar shape to the structure, wherein when nested the respective floors of the structure and the second structure are a distance not to exceed 1 inch apart;
wherein the floor, the left wall, the right wall, the front wall and the rear wall are formed as a single injection molded plastic structure resulting in a monolithic structure;
wherein the rear wall is formed in the shape of a U-shaped perimeter, the U-shaped perimeter extending perpendicularly from the left wall, the floor and the rear wall a distance equal to or less than 2 inches; and
wherein the first obtuse angle is at least 95 degrees but no greater than 135 degrees, wherein the second obtuse angle is at least 95 degrees but no greater than 135 degrees, and wherein the third obtuse angle is at least 95 degrees.
